(19) United States
(12) Patent Application Publication
(10) Pub. No.: US 2006/0186814 A1
(43) Pub. Date: Aug. 24, 2006

(54) Electrode terminal part connection structure and plasma display panel having the same

(76) Inventor: Jae-Ik Kwon, Suwon-si (KR)

Correspondence Address: Robert E. Bushnell, Suite 300, 1522 K Street, N.W., Washington, DC, 20005-1202, US

(21) Appl. No.: 11/350,810

(22) Filed: Feb. 10, 2006

(30) Foreign Application Priority Data
Feb. 23, 2005 (KR) 10-2005-0015003

(51) Int. Cl. H01J 17/49

(52) U.S. Cl. 313/583; 313/585; 313/582

(57) ABSTRACT

An electrode terminal part connection structure for a plasma display panel is capable of stably connecting signal transmitting means to a terminal part of a discharge electrode. The electrode terminal part connection structure includes: a pair of substrates facing each other; a barrier rib interposed between the substrates so as to define discharge cells together with the substrates; a dielectric layer interposed between the substrates; discharge electrodes, each having a discharge part located within the barrier rib, a terminal part located outside the barrier rib and contacting the dielectric layer, and a connection part connecting the discharge electrode to the terminal part; and signal transmitting means having an end portion which contacts the terminal parts.

### CLAIM OF PRIORITY

This application makes reference to, incorporates the same herein, and claims all benefits accruing under 35 U.S.C. § 119 from an application for STRUCTURE FOR CONNECTING TERMINAL PART OF ELECTRODE AND PLASMA DISPLAY PANEL COMPRISING THE SAME earlier filed in the Korean Intellectual Property Office on 23 Feb. 2005 and there duly assigned Serial No. 10-2005-0015003.

### BACKGROUND OF THE INVENTION

1. Field of the Invention

The present invention relates to an electrode terminal part connection structure and a plasma display panel having the electrode terminal part connection structure and, more particularly, to an electrode terminal part connection structure for securely supporting discharge electrode terminal parts by forming the discharge electrode terminal parts in contact with a substrate or a dielectric layer, and a plasma display panel having the electrode terminal part connection structure.

2. Description of the Related Art

Recently, plasma display panels (PDPs) have been widely used as a substitute for cathode ray tubes (CRTs). A PDP includes two substrates having electrodes and discharge cells filled with a discharge gas. When a discharge voltage is applied to the electrodes, ultra-violet (UV) light is generated to excite phosphor layers in the discharge cells. Visible light emitted from the excited phosphor layers is used to form an image.

In order to drive the PDP, a driving circuit board applies a voltage derived from an image signal. In general, the driving circuit board is connected to the discharge electrode terminal parts through signal transmitting means.

In a facing discharge PDP wherein sustain electrodes are located within barrier ribs, only the terminal parts of the electrodes are exposed. In this case, since the electrode terminal part structure is weak, there is a problem in that the terminal parts of the electrodes may be broken when the terminal parts are connected to the signal transmitting means.

This is due to the fact that, if only the terminal part of the electrode is exposed, the terminal part of the electrode has the shape of a cantilever beam, and since the terminal part of the electrode is generally formed by a printing method, the terminal part is weak and can be easily broken. In addition, when the terminal part of the electrode is connected to the signal transmitting means, a shear force or a bending moment is exerted on the terminal part, and this can easily break the terminal part. As a result, the connection of the terminal part causes many defects and increases production cost.

### SUMMARY OF THE INVENTION

The present invention provides an electrode terminal part connection structure capable of stably supporting a terminal part of a discharge electrode by forming the terminal part of the discharge electrode so as to contact a substrate or a dielectric layer, and a plasma display panel having the structure.

According to an aspect of the present invention, an electrode terminal part connection structure for a plasma display panel comprises: a pair of substrates facing each other; a barrier rib interposed between the substrates so as to define discharge cells together with the substrates; a dielectric layer interposed between the substrates; discharge electrodes, each having a discharge part located within the barrier rib, a terminal part located outside the barrier rib and contacting the dielectric layer, and a connection part connecting the discharge part to the terminal part; and signal transmitting means having an end portion which contacts the terminal parts of the discharge electrode.

The length of the substrates may be more than the length of the barrier rib.

A side wall of the barrier rib may be covered with a barrier rib protective layer.

The discharge electrodes may be common electrodes.

The discharge electrodes may be scan electrodes.

The signal transmitting means may be flexible printed cables.

The signal transmitting means may be connected to the terminal parts using an anisotropic conductive film.

According to another aspect of the present invention, an electrode terminal part connection structure for a plasma display panel comprises: a pair of substrates facing each other; a barrier rib interposed between the substrates so as to define discharge cells together with the substrates; discharge electrodes, each having a discharge part located within the barrier rib, a terminal part located outside the barrier rib and contacting one of the substrates, and a connection part connecting the discharge part to the terminal part; and signal transmitting means having an end portion which contacts the terminal parts of the discharge electrodes.

The length of the substrates may be more than the length of the barrier rib.

Surfaces of the substrate may be covered with a substrate protective layer.

A side wall of the barrier rib may be covered with a barrier rib protective layer.

The discharge electrodes may be common electrodes.

The discharge electrodes may be scan electrodes.

The signal transmitting means may be flexible printed cables.

The signal transmitting means may be connected to the terminal parts using an anisotropic conductive film.

According to still another aspect of the present invention, an electrode terminal part connection structure for a plasma display panel comprises: a pair of substrates facing each other; a first barrier rib interposed between the substrates so as to define discharge cells together with the substrates; a second barrier rib interposed between the substrates so as to define the discharge cells together with the substrates and the first barrier rib; a dielectric layer interposed between the substrates; discharge electrodes, each having a discharge part located within the first barrier rib, a terminal part located outside the second barrier rib and contacting the dielectric layer, and a connection part connecting the discharge part to the terminal part; and signal transmitting means having an end portion which contacts the terminal parts of the discharge electrodes.

The length of the substrates may be more than the length of the first barrier rib.

The length of the substrates may be more than the length of the second barrier rib.

A side wall of the first barrier rib may be covered with a barrier rib protective layer.

The discharge electrodes may be common electrodes.

The discharge electrodes may be scan electrodes.

The signal transmitting means may be flexible printed cables.

The signal transmitting means may be connected to the terminal parts using an anisotropic conductive film.

According to another aspect of the present invention, an electrode terminal part connection structure for a plasma display panel comprises: a pair of substrates facing each other; a first barrier rib interposed between the substrates so as to define discharge cells together with the substrates; a second barrier rib interposed between the substrates so as to define the discharge cells together with the substrates and the first barrier rib; discharge electrodes, each having a discharge part located within the first barrier rib, a terminal part located outside the second barrier rib and contacting one of the substrates, and a connection part connecting the discharge part to the terminal part; and signal transmitting means having an end portion which contacts the terminal parts of the discharge electrodes.

The length of the substrates may be more than the length of the first barrier rib.

The length of the substrates may be more than the length of the second barrier rib.

Surfaces of the substrate may be covered with a substrate protective layer.

A side wall of the first barrier rib may be covered with a barrier rib protective layer.

The discharge electrodes may be common electrodes.

The discharge electrodes may be scan electrodes.

The signal transmitting means may be flexible printed cables.

The signal transmitting means may be connected to the terminal parts using an anisotropic conductive film.

According to another aspect of the present invention, a plasma display panel comprises: a pair of substrates facing each other; a barrier rib interposed between the substrates so as to define discharge cells together with the substrates; a dielectric layer interposed between the substrates; sustain electrodes, each having a discharge part located within the barrier rib, a terminal part located outside the barrier rib and contacting the dielectric layer, and a connection part connecting the discharge parts of the sustain electrodes to the terminal parts thereof; address electrodes interposed between the substrates and extending in a direction intersecting a direction of the sustain electrodes; signal transmitting means having an end portion which contacts the terminal parts of the sustain electrodes; phosphor layers located in the discharge cells; and a discharge gas filling the discharge cells.

The length of the substrates may be more than the length of the barrier rib.

At least one of the substrates may be transparent.

A side wall of the barrier rib may be covered with a barrier rib protective layer.

Each of the sustain electrodes may comprise a common electrode and a scan electrode.

The signal transmitting means may be flexible printed cables.

The signal transmitting means may be connected to the terminal parts using an anisotropic conductive film.

According to another aspect of the present invention, a plasma display panel comprises: a pair of substrates facing each other; a barrier rib interposed between the substrates so as to define discharge cells together with the substrates; sustain electrodes, each having a discharge part located within the barrier rib, a terminal part located outside the barrier rib and contacting one of the substrates, and a connection part connecting the discharge part to the terminal part; address electrodes interposed between the substrates and extending in a direction intersecting a direction of the sustain electrodes; signal transmitting means having an end portion which contacts the terminal parts of the sustain electrodes; phosphor layers located in the discharge cells; and a discharge gas filling the discharge cells.

The length of the substrates may be more than the length of the barrier rib.

At least one of the substrates may be transparent.

Surfaces of the substrate may be covered with a substrate protective layer.

A side wall of the barrier rib may be covered with a barrier rib protective layer.

Each of the sustain electrodes may comprise a common electrode and a scan electrode.

The signal transmitting means may be flexible printed cables.

The signal transmitting means may be connected to the terminal parts using an anisotropic conductive film.

### BRIEF DESCRIPTION OF THE DRAWINGS

A more complete appreciation of the invention and many of the attendant advantages thereof will be readily apparent as the same becomes better understood by reference to the following detailed description when considered in conjunction with the accompanying drawings in which like reference symbols indicate the same or similar components, wherein:

FIG. 1 is a cutaway perspective view of a plasma display panel having an electrode terminal part connection structure according to a first embodiment of the present invention;

FIG. 2 is a cross sectional view taken along line II-II of FIG. 1;

FIG. 3 is a cutaway perspective view of a plasma display panel having an electrode terminal part connection structure according to a second embodiment of the present invention;

FIG. 4 is a cross sectional view taken along line IV-IV of FIG. 3;

FIG. 5 is a cutaway perspective view of a plasma display panel having an electrode terminal part connection structure according to a third embodiment of the present invention;

FIG. 6 is a cross sectional view taken along line IV-IV of FIG. 5; and

FIG. 7 is a cross sectional view of a plasma display panel having an electrode terminal part connection structure according to a modified version of the third embodiment of the present invention.

### DETAILED DESCRIPTION OF THE INVENTION

The invention will now be described in more detail with reference to the various figures of the drawings.

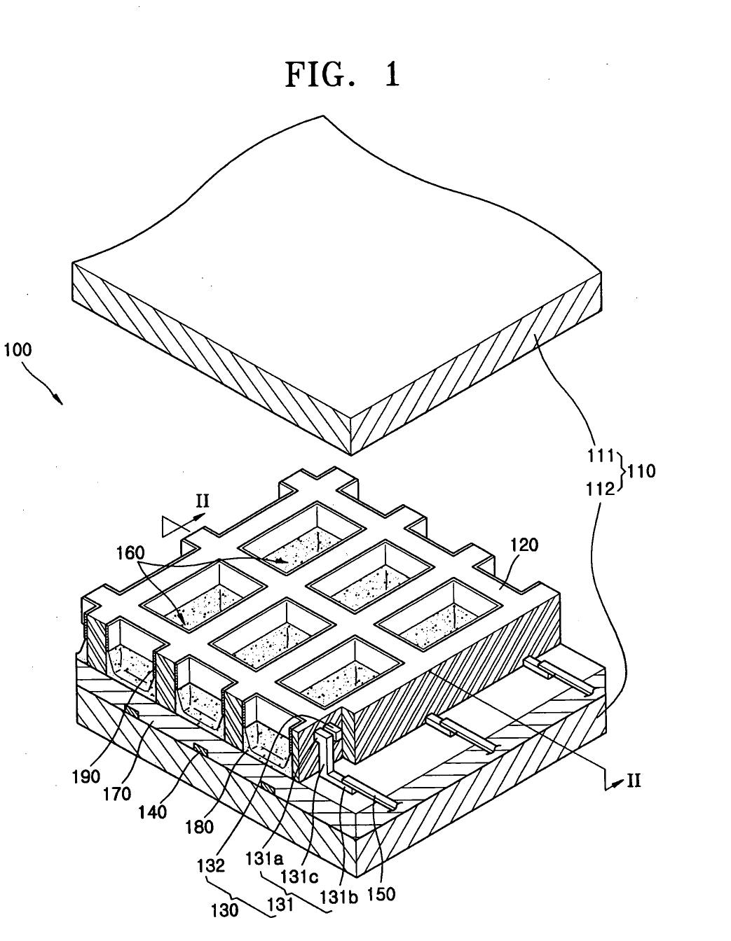

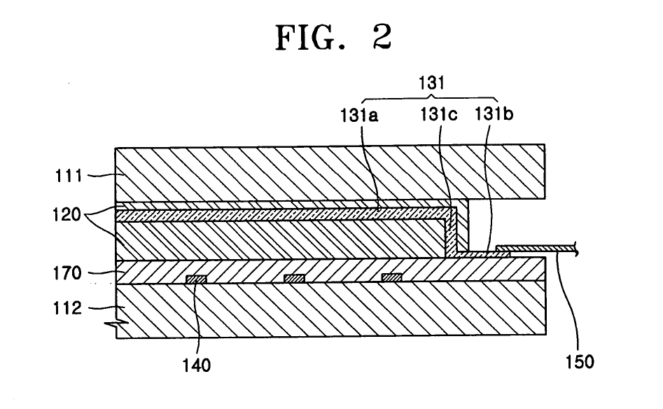

FIG. 1 is a cutaway perspective view of a plasma display panel having an electrode terminal part connection structure according to a first embodiment of the present invention. FIG. 2 is a cross sectional view taken along line II-II of FIG. 1.

The plasma display panel having the electrode terminal part connection structure according to the first embodiment of the present invention includes a substrate pair 110, a barrier rib 120, sustain electrode pairs 130, address electrodes 140, and signal transmitting means 150.

The substrate pair 110 includes first substrate 111 and second substrate 112 facing each other. The first substrate 111 is made of transparent glass which is capable of transmitting visible light.

More specifically, in the first embodiment, the first substrate 111 is made of transparent glass so that visible light generated by phosphor layers 180 can pass through the first substrate 111. However, the present invention is not limited to this structure. Alternatively, the second substrate 112 may be made of a transparent material so that visible light generated by the phosphor layers 180 can pass through the second substrate 112.

The first substrate 111 and second substrate 112, together with the barrier rib 120, define a plurality of discharge cells 160.

The lengths of the first substrate 111 and second substrate 112 are more than a length of the barrier rib 120. Therefore, the first substrate 111 and second substrate 112, together with the barrier rib 120, can sufficiently define the discharge cells 160. In addition, the signal transmitting means 150 can be easily located in a portion where the barrier rib 120 is not located on the first and second substrates 111 and 112, respectively.

In addition, in the first embodiment, the cross section of each discharge part 160 as defined by the barrier rib 120 has the shape of a rectangle. However, the present invention is not limited to this shape. Alternatively, various shapes, such as a triangle, a pentagon, a polygon, a circle and an ellipse, may be employed for the discharge cells 160.

The barrier rib 120 is interposed between the first and second substrates 111 and 112, respectively. The barrier rib 120 is made of a dielectric material. The sustain electrode pairs 130 are located within the barrier rib 120.

The dielectric material constituting the barrier rib 120 prevents charged particles from directly colliding with the sustain electrode pairs 130 so as to protect the sustain electrode pairs 130. In addition, the dielectric material induces the charged particles and accumulates wall charge. The dielectric material is preferably PbO, B₂O₃, SiO₂, or the like.

The sustain electrode pairs 130 located within the barrier rib 120 serve as discharge electrodes, including common electrode 131 and scan electrode 132.

In the first embodiment, since the sustain electrode pairs 130 are located within the barrier rib 120 of the plasma display panel 100, the common and scan electrodes 131 and 132, respectively, need not be made of a transparent material, but can be made of a highly-conductive (low resistance) metal, such as Ag, Al, or Cu. This provides many advantages, such as a faster response rate for discharge, low signal distortion, and reduced power consumption required for sustain discharge.

In the first embodiment, discharge parts 131a of the common electrode 131 and a discharge part (not shown) of the scan electrode 132 have a straight line shape. However, the present invention is not limited to this shape. Alternatively, various shapes such as a ladder, a ring and a lateral ring may be employed so as to surround the discharge cells 160. In this case, the sustain discharge is generated perpendicular to all of the side walls defining the discharge part 160. Therefore, the discharge area can be enlarged, and a low driving voltage can be used, so that it is possible to increase luminous efficiency.

The address electrodes 140 are located on the front surface of the second substrate 112 and extend in a direction intersecting the common and scan electrodes 131 and 132, respectively. The address electrodes 140, together with the scan electrodes 132, perform address discharge so as to select discharge cells wherein the discharge is to be generated.

In the first embodiment, since the discharge parts 131a of the common electrode 131 and the discharge part (not shown) of the scan electrodes 132 have a straight line shape extending in the same direction, the address electrodes 140 are needed in order to perform address discharge so as to select the discharge cells wherein the discharge is to be generated. However, the present invention is not limited to this structure. Alternatively, as described above, in the case of the plasma display panel wherein the discharge parts of the common and scan electrodes have the shape of a ladder, a ring or the like so as to surround the discharge cells, a structure wherein the discharge parts of the common and scan electrodes intersect each other has an addressing function so that separate address electrodes 140 are not needed.

A dielectric layer 170 is located so as to cover the address electrodes 140. The dielectric layer 170 prevents positive ions or electrons from colliding with the address electrodes 140 so as to protect the address electrodes 140. In addition, the dielectric layer 170 induces charged particles. The dielectric layer 170 is preferably made of PbO, B₂O₃, SiO₂, or the like.

The phosphor layers 180 are located on lower surfaces of the discharge cells 160 and lower side walls of the barrier rib 120. However, the present invention is not limited to this structure of the phosphor layers 180. Alternatively, the phosphor layers 180 may be located on various regions of the discharge cells 160, for example, on upper surfaces of the discharge cells 160.

The phosphor layers 180 include components capable of receiving ultraviolet light and emitting visible light. A red phosphor layer located in a red light emitting discharge part includes a fluorescent material such as Y(V,P)O₄:Eu. A green phosphor layer located in a green light emitting discharge part includes a fluorescent material such as Zn₂SiO4:Mn. A blue phosphor layer located in a blue light emitting discharge part includes a fluorescent material such as BAM:Eu.

A barrier rib protective layer 190 is located on the side walls of the barrier rib 120 where the phosphor layers 180 are not located.

The barrier rib protective layer 190 prevents the barrier rib 120, made of dielectric materials and electrodes, from being damaged by sputtering of plasma particles. In addition, the barrier rib protective layer 190 reduces discharge voltage by emitting secondary electrons. The barrier rib protective layer 190 is preferably made of magnesium oxide (MgO).

The discharge cells 160, defined by the first and second substrates 111 and 112, respectively, and the barrier rib 120, are filled with a discharge gas such as Ne, Xe, or a mixture thereof.

As described above, the sustain electrode pairs 130, serving as discharge electrodes, include common and scan electrodes 131 and 132, respectively.

The common electrodes 131 and scan electrodes 132 have identical structures except that the electrodes are formed symmetrically in order to be easily connected to the driving circuit board (not shown) by the signal transmitting means 150. Therefore, only the common electrode 131 will be representatively described.

The common electrode 131 includes a discharge part 131a, a terminal part 131b, and a connection part 131c. The structure is as follows.

The discharge part 131a is located within a barrier rib 120 so as to perform discharge. The discharge part 131a is formed so as to be higher than the phosphor layer 180.

The terminal part 131b is located on the dielectric layer 170 so that the dielectric layer 170 can support the terminal part 131b.

In addition, the terminal part 131b is located outside the barrier rib 120 so that the terminal part 131b can be connected to the signal transmitting means 150. As described, the lengths of the first substrate 111 and second substrate 112 are formed so as to be more than the length of the barrier rib 120, so that there are some portions along the edges of the first substrate 111 and second substrate 112 where the barrier rib 120 is not formed. In these portions, the signal transmitting means 150 is electrically connected to the terminal part 131b.

The connection part 131c is formed so as to electrically connect the discharge part 131a to the terminal part 131b.

In the first embodiment, the connection part 131c is located within the barrier rib 120, but the present invention is not limited thereto. That is, if the connection part 131c can be formed to connect the discharge part 131a to the terminal part 131b, the connection part 131c may be located outside the barrier rib 120. In addition, in the case where the connection part 131c is located outside the barrier rib 120, the connection part 131c is covered with a thin insulating layer so as to protect the connection part 131c.

In the first embodiment, the discharge part 131a, the terminal part 131b and the connection part 131c are made of the same material, but the present invention is not limited thereto. For example, the discharge part 131a, the terminal part 131b and the connection part 131c may be made of different materials. That is, if the discharge part 131a, the terminal part 131b and the connection part 131c are constructed of electrically conductive materials, any materials can be selected without particular limitation.

The signal transmitting means 150 is electrically connected to an upper portion of the terminal part 131b. In the first embodiment, the signal transmitting means 150 contacts an upper surface of the terminal part 131b, which is opposite to the lower surface of the terminal part 131b which contacts the dielectric layer 170.

When the signal transmitting means 150 is attached to the terminal part 131b, an external force is exerted on the terminal part 131b. In the first embodiment, the terminal part 131b is formed on the dielectric layer 170 so that no drooping of the terminal part 131b can occur, and the terminal part 131b can effectively resist a shear force and a bending moment.

The signal transmitting means 150 may be a flexible printed cable (FPC). In this case, the terminal parts 131b are respectively connected to the wires of the flexible printed cable.

In the latter regard, the wires of the signal transmitting means 150 may be connected to the terminal part 131b using an anisotropic conductive film.

As described above, the common electrode 131 has a symmetrical structure relative to the scan electrode 132, so that a discharge part (not shown), a terminal part (not shown) and a connection part (not shown) of the scan electrode 132 have the same structure as the discharge part 131a, the terminal part 131b and the connection part 131c, respectively, of the common electrode 131.

In other words, although not shown in FIGS. 1 and 2, the array structure of the barrier rib 120, the terminal part 131b of the common electrode 131, the connection part 131c, and the signal transmitting means 150 are also formed symmetrically on the opposite edge of the plasma display panel 100.

On the other hand, in the first embodiment, although the terminal part 131b of the common electrode 131 and the terminal part (not shown) of the scan electrode 132 are formed on the dielectric layer 170, the present invention is not limited thereto.

Specifically, since the dielectric layer 170 is not an essential component of a plasma display panel, there may be a plasma display panel having no dielectric layer 170. In particular, as described above, in the case where the discharge parts of the common and scan electrodes 131 and 132, respectively, of the plasma display panel 100 have the shape of a ladder or a ring so as to surround the discharge cells 160, if the discharge parts of the common and scan electrodes 131 and 132, respectively, intersect each other, there is no need to provide a separate address electrode 140. In that case, the dielectric layer 170 may also be unnecessary.

In the case where there is need to provide an additional dielectric layer 170, either the terminal part 131b of the common electrode 131 or a terminal part (not shown) of the scan electrode 132 may contact the first substrate 111 or the second substrate 112. In this case, the terminal part 131b of the common electrode 131 and the terminal part (not shown) of the scan electrode 132 are stably supported by the first substrate 111 or second substrate 112. Therefore, when the terminal parts are connected to the signal transmitting means 150, although a force is exerted on the terminal parts, the terminal parts remain unbroken and are stably connected to the signal transmitting means 150.

In other words, the present invention can be applied to a plasma display panel having no dielectric layer 170. In this case, the terminal part 131b of the common electrode 131 and the terminal part (not shown) of the scan electrode 132 can be stably supported by either the first substrate 111 or second substrate 112.

Next, the operation of a plasma display panel 100 having the electrode terminal part connection structure according to the first embodiment will be described.

First, when the barrier ribs 120 and the sustain electrode pairs 130 of the plasma display panel 100 are formed, the discharge part 131a, the terminal part 131b, and the connection part 131c of the common electrode 131, and a discharge part (not shown), a terminal part (not shown), and a connection part (not shown) of the scan electrode 132, are formed with the above-described structures according to the first embodiment. Next, the wires of the signal transmitting means 150 are electrically connected to the terminal part 131b of the common electrode 131 and the terminal part (not shown) of the scan electrode 132.

After assembling the plasma display panel 100 and injecting the discharge gas, an address voltage is applied to the address electrode 140 and the scan electrode 132 by an external power source (not shown) so as to generate address discharge. The address discharge selects a discharge part 160 wherein sustain discharge is to be generated.

After that, a discharge sustain voltage is applied to the common and scan electrodes 131 and 132, respectively, of the selected discharge part 160 through the signal transmitting means 150 so that wall charges accumulated on the common and scan electrodes 131 and 132, respectively, move so as to generate a sustain discharge. When the discharge gas excited during the sustain discharge drops to a lower energy state, UV light is emitted.

The UV light excites the phosphor layer 180 coated in the discharge part 160. When the excited phosphor layer 180 drops to a lower energy state, visible light is emitted. The visible light passes out through the first substrate 111 so as to form an image which can be viewed by a user.

In the first embodiment, the terminal part 131b of the common electrode 131 and the terminal part (not shown) of the scan electrode 132 are formed on the dielectric layer 170 on the front surface of the second substrate 112, so that the terminal part 131b of the common electrode 131 and the terminal part (not shown) of the scan electrode 132 can be stably supported. Accordingly, when the wires of the signal transmitting means 150 are connected to the terminal part 131b of the common electrode 131 and the terminal part (not shown) of the scan electrode 132, although an external force is exerted on the terminal parts, the terminal parts are protected from breakage.

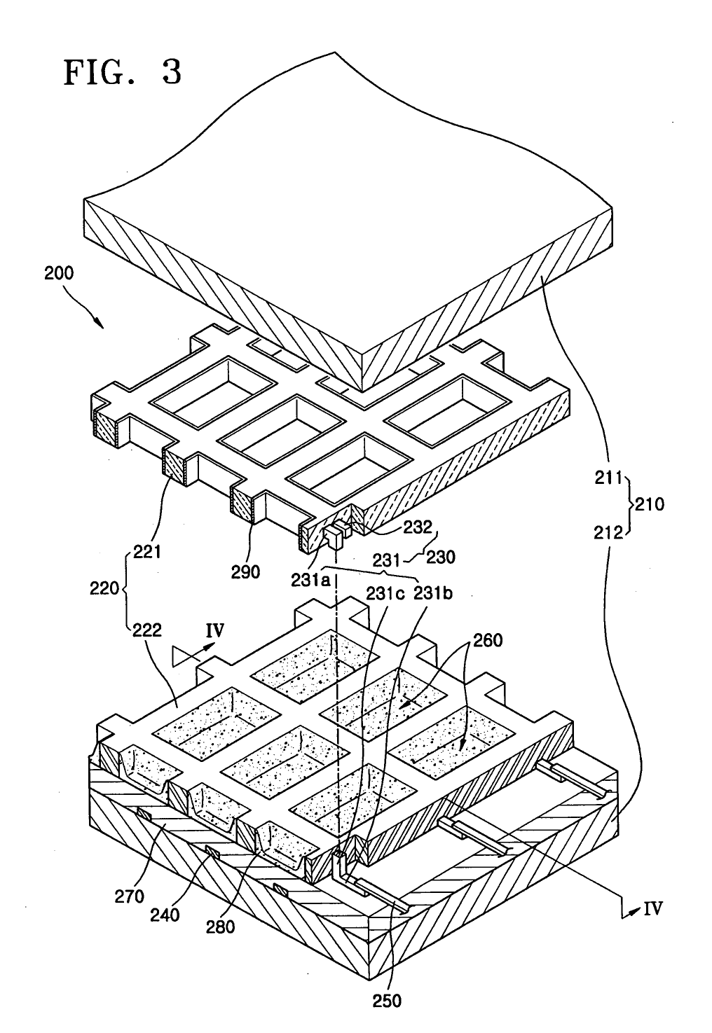

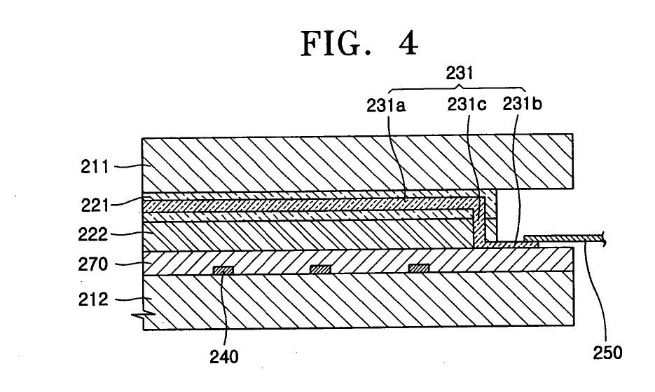

A second embodiment of the present invention will now be described with reference to FIGS. 3 and 4.

FIG. 3 is a cutaway perspective view of a plasma display panel having an electrode terminal part connection structure according to a second embodiment of the present invention. FIG. 4 is a cross sectional view taken along line IV-IV of FIG. 3.

The plasma display panel 200 having the electrode terminal part connection structure according to the second embodiment of the present invention includes a substrate pair 210, a barrier rib 220, sustain electrode pairs 230, address electrodes 240, and signal transmitting means 250.

The substrate pair 210 includes first substrate 211 and second substrate 212 facing each other. The first substrate 211 is made of transparent glass which is capable of transmitting visible light.

More specifically, in the second embodiment, the first substrate 211 is made of transparent glass so that visible light generated from phosphor layers 280 can pass through the first substrate 211. However, the present invention is not limited to this structure. Alternatively, the second substrate 212 may be made of a transparent material so that visible light generated by phosphor layers 280 can pass through the second substrate 212.

The barrier rib 220 includes first and second barrier ribs 221 and 222, respectively.

The first substrate 211 and second substrate 212, together with the first and second barrier ribs 221 and 222, respectively, define a plurality of discharge cells 260.

The lengths of the first substrate 211 and second substrate 212 are longer than the lengths of the first and second barrier ribs 221 and 222, respectively. Therefore, the first substrate 211 and second substrate 212, together with the first and second barrier ribs 221 and 222, respectively, can sufficiently define the discharge cells 260. In addition, the signal transmitting means 250 can easily be located in a portion where the first and second barrier ribs 221 and 222, respectively, are not located on the first and second substrates 211 and 212, respectively.

In addition, in the second embodiment, the cross section of each discharge part 260 defined by the first and second barrier ribs 221 and 222, respectively, has the shape of a rectangle. However, the present invention is not limited to this shape. Alternatively, various shapes, such as a triangle, a pentagon, a polygon, a circle and an ellipse, may be employed.

The first barrier rib 221 is interposed between the first substrate 211 and second substrate 212. The first barrier rib 221 is made of a dielectric material. The sustain electrode pairs 230 are located within the first barrier rib 221.

Although the first barrier rib 221 can be formed so as to extend from the second barrier rib 222, it is preferable that the first barrier rib 221 be formed so as to extend from the first substrate 211.

The dielectric material constituting the first barrier rib 221 prevents charged particles from colliding directly with the sustain electrode pairs 230 in order to protect the sustain electrode pairs 230. In addition, the dielectric material induces the charged particles and accumulates wall charge. The dielectric material is preferably PbO, B₂O₃, SiO₂, or the like.

The sustain electrode pairs 230 located within the first barrier rib 221 serve as discharge electrodes, including common electrode 231 and scan electrode 232.

The second barrier rib 222 is interposed between the first and second substrates 211 and 212, respectively. The second barrier rib 222 is located under the first barrier rib 221, and is made of a dielectric material.

In the second embodiment, since the sustain electrode pairs 230 are located within the first barrier rib 221 of the plasma display panel 200, the common and scan electrodes 231 and 232, respectively, constituting the sustain electrode pair 230 need not be made of a transparent material, but can be made of a highly-conductive (low resistance) metal, such as Ag, Al, or Cu. This provides many advantages, such as faster response rate, lower signal distortion, and reduced power consumption required for sustain discharge.

In the second embodiment, discharge parts 231a of the common electrode 231 and a discharge part (not shown) of the scan electrodes 232 have a straight line shape. However, the present invention is not limited to this shape. Alternatively, various shapes such as a ladder, a ring and a lateral ring may be employed so as to surround the discharge cells 260. In this case, the sustain discharge is generated perpendicular to all of the side walls defining the discharge part 260. Therefore, the discharge area can be enlarged, and a low driving voltage can be used, so that it is possible to increase luminous efficiency.

The address electrodes 240 are located on the front surface of the second substrate 212 and extend in a direction intersecting the common and scan electrodes 231 and 232, respectively. The address electrodes 240, together with the scan electrodes 232, perform address discharge so as to select discharge cells wherein the discharge is to be generated.

In the second embodiment, since the discharge parts 231a of the common electrode 231 and the discharge part (not shown) of the scan electrodes 232 have a straight line shape, the address electrodes 240 must be separate in order to perform address discharge so as to select the discharge cells wherein the discharge is to be generated. However, the present invention is not limited to this structure. Alternatively, as described above, in the case of the plasma display panel wherein the discharge parts of the common and scan electrodes have the shape of a ladder, a ring, or the like so as to surround the discharge cells, a structure wherein the discharge parts of the common and scan electrodes intersect each other has an addressing function so that separate address electrodes 240 are not needed.

A dielectric layer 270 is located so as to cover the address electrodes 240. The dielectric layer 270 prevents positive ions or electrons from colliding with the address electrodes 240 so as to protect the address electrodes 240. In addition, the dielectric layer 270 induces charged particles. The dielectric layer 270 is preferably made of PbO, B₂O₃, SiO₂, or the like.

The phosphor layers 280 are located on lower surfaces of the discharge cells 260 and lower side walls of the second barrier rib 222. However, the present invention is not limited to this structure of the phosphor layers 280. Alternatively, the phosphor layers 280 may be located on various regions of the discharge cells 260, for example, on upper surfaces of the discharge cells 260.

The phosphor layer 280 includes the same fluorescent material as the phosphor layer 180 of the first embodiment, and thus a description thereof is omitted.

A barrier rib protective layer 290 is located on the side walls of the first barrier rib 221 where the phosphor layers 280 are not disposed.

The barrier rib protective layer 290 is made of the same material as the barrier rib protective layer 190 of the first embodiment, and has the same function as the barrier rib protective layer 190 of the first embodiment, and thus a description thereof is omitted.

The discharge cells 260, defined by the first and second substrates 211 and 212, respectively, and the first and second barrier ribs 221 and 222, respectively, are filled with a discharge gas such as Ne, Xe, or a mixture thereof.

As described above, the sustain electrode pairs 230, serving as discharge electrodes, include common and scan electrodes 231 and 232, respectively.

The common and scan electrodes 231 and 232, respectively, have identical structures except that the electrodes are formed symmetrically in order to be easily connected to the driving circuit board (not shown) by the signal transmitting means 250. Therefore, only the common electrode 231 will be representatively described.

The common electrode 231 includes a discharge part 231a, a terminal part 231b, and a connection part 231c. The structure is as follows.

The discharge part 231a is located within a first barrier rib 221 so as to perform discharge.

The terminal part 231b is located on the dielectric layer 270 so that the dielectric layer 270 can support the terminal part 231b.

In addition, the terminal part 231b is located outside the second barrier rib 222 so that the terminal part 231b can be connected to the signal transmitting means 250. As described, the lengths of the first and second substrates 211 and 212, respectively, are formed so as to be longer than the lengths of the first and second barrier ribs 221 and 222, respectively, so that there are some portions along the edges of the first and second substrates 211 and 212, respectively, where the first and second barrier ribs 221 and 222, respectively, are not formed. In those portions, the signal transmitting means 250 is electrically connected to the terminal part 231b.

The connection part 231c is formed so as to electrically connect the discharge part 231a to the terminal part 231b. Some portion of the connection part 231 is located within the first barrier rib 221, and another portion of the connection part 231 is located within the second barrier rib 222, so that the connection part 231c electrically connects the discharge part 231a to the terminal part 231b.

In the second embodiment, the connection part 231c is located within the first and second barrier ribs 221 and 222, respectively, but the present invention is not limited thereto. That is, if the connection part 231c can be formed to connect the discharge part 231a to the terminal part 231b, the connection part 231c may be located outside the barrier rib 220. In addition, in the case where the connection part 231c is located outside the barrier rib 220, the connection part 231c is covered with a thin insulating layer so as to protect the connection part 231c.

In the second embodiment, the discharge part 231a, the terminal part 231b and the connection part 231c are made of the same material, but the present invention is not limited thereto. For example, the discharge part 231a, the terminal part 231b and the connection part 231c may be made of different materials. That is, if the discharge part 231a, the terminal part 231b and the connection part 231c are constructed of electrically conductive materials, any materials can be selected without particular limitation.

The signal transmitting means 250 is electrically connected to an upper portion of the terminal part 231b. In the second embodiment, the signal transmitting means 250 contacts one of the two surfaces of the terminal part 231b, which is opposite to the lower surface of the terminal part 231 which contacts the dielectric layer 270.

When the signal transmitting means 250 is attached to the terminal part 231b, an external force is exerted on the terminal part 231b. In the second embodiment, the terminal part 231b is formed on the dielectric layer 270 so that no drooping of the terminal part 231b can occur, and the terminal part 231b can effectively resist a shear force and a bending moment.

The signal transmitting means 250 may be a flexible printed cable (FPC). In this case, the terminal parts 231b are respectively connected to the wires of the flexible printed cable.

In the latter regard, the wires of the signal transmitting means 250 may be connected to the terminal part 231b using an anisotropic conductive film.

As described above, the common electrode 231 has a symmetrical structure relative to the scan electrode 232, so that a discharge part (not shown), a terminal part (not shown) and a connection part (not shown) of the scan electrode 232 have the same structure as the discharge part 231a, the terminal part 231b and the connection part 231c, respectively, of the common electrode 231.

In other words, although not shown in FIGS. 3 and 4, the array structure of the first and second barrier ribs 221 and 222, respectively, the terminal part 231b of the common electrode 231, the connection part 231c, and the signal transmitting means 250 are also formed symmetrically on the opposite edge of the plasma display panel 200.

On the other hand, in the second embodiment, although the terminal part 231b of the common electrode 231 and the terminal part (not shown) of the scan electrode 232 are formed on the dielectric layer 270, the present invention is not limited thereto.

Specifically, since the dielectric layer 270 is not an essential component for a plasma display panel, there may be a plasma display panel having no dielectric layer 270. In particular, as described above, in the case where the discharge parts of the common and scan electrodes 231 and 232, respectively, of the plasma display panel 200 have the shape of a ladder or a ring so as to surround the discharge cell 260, if the discharge parts of the common and scan electrodes 231 and 232, respectively, intersect each other, there is no need to provide a separate address electrode 240. Therefore, the dielectric layer 270 may also be unnecessary.

In the case where there is need to provide an additional dielectric layer 270, either the terminal part 231b of the common electrode 231 or a terminal part (not shown) of the scan electrode 232 may contact the first substrate 211 or the second substrate 212. In this case, the terminal part 231b of the common electrode 231 and the terminal part (not shown) of the scan electrode 232 are stably supported by the first substrate 211 or second substrate 212. Therefore, when the terminal parts are connected to the signal transmitting means 250, although a force is exerted on the terminal parts, the terminal parts remain unbroken and are stably connected to the signal transmitting means 250.

In other words, the present invention can be applied to a plasma display panel having no dielectric layer 270. In this case, the terminal part 231b of the common electrode 231 and the terminal part (not shown) of the scan electrode 232 can be stably supported by either the first substrate 211 or second substrate 212.

Next, the operation of a plasma display panel 200 having the electrode terminal part connection structure according to the second embodiment will be described.

First, when the first and second barrier ribs 221 and 222, respectively, and the sustain electrode pairs 230 of the plasma display panel 200 are formed, the discharge part 231a, the terminal part 231b, and the connection part 231c of the common electrode 231, and a discharge part (not shown), a terminal part (not shown), and a connection part (not shown) of the scan electrode 232, are formed with the above-described structures according to the second embodiment. Next, the wires of the signal transmitting means 250 are electrically connected to the terminal part 231b of the common electrode 231 and the terminal part (not shown) of the scan electrode 232.

After assembling the plasma display panel 200 and injecting the discharge gas, an address voltage is applied to the address electrode 240 and the scan electrode 232 by an external power source (not shown) so as to generate address discharge. The address discharge selects a discharge part 260 wherein sustain discharge is to be generated.

After that, a discharge sustain voltage is applied to the common and scan electrodes 231 and 232, respectively, of the selected discharge part 260 through the signal transmitting means 250 so that wall charges accumulated on the common and scan electrodes 231 and 232, respectively, move so as to generate a sustain discharge. When the discharge gas excited during the sustain discharge drops to a lower energy state; UV light is emitted.

The UV light excites the phosphor layer 280 coated in the discharge part 260. When the excited phosphor layer 280 drops to a lower energy state, visible light is emitted. The emitting visible light passes out through the first substrate 211 so as to form an image which can be viewed by a user.

In the second embodiment, the terminal part 231b of the common electrode 231 and the terminal part (not shown) of the scan electrode 232 are formed on the dielectric layer 270 located on the front surface of the second substrate 212, so that the terminal part 231b of the common electrode 231 and the terminal part (not shown) of the scan electrode 232 can be stably supported. Accordingly, when the wires of the signal transmitting means 250 are connected to the terminal part 231b of the common electrode 231 and the terminal part (not shown) of the scan electrode 232, although an external force is exerted on the terminal parts, the terminal parts are protected from breakage.

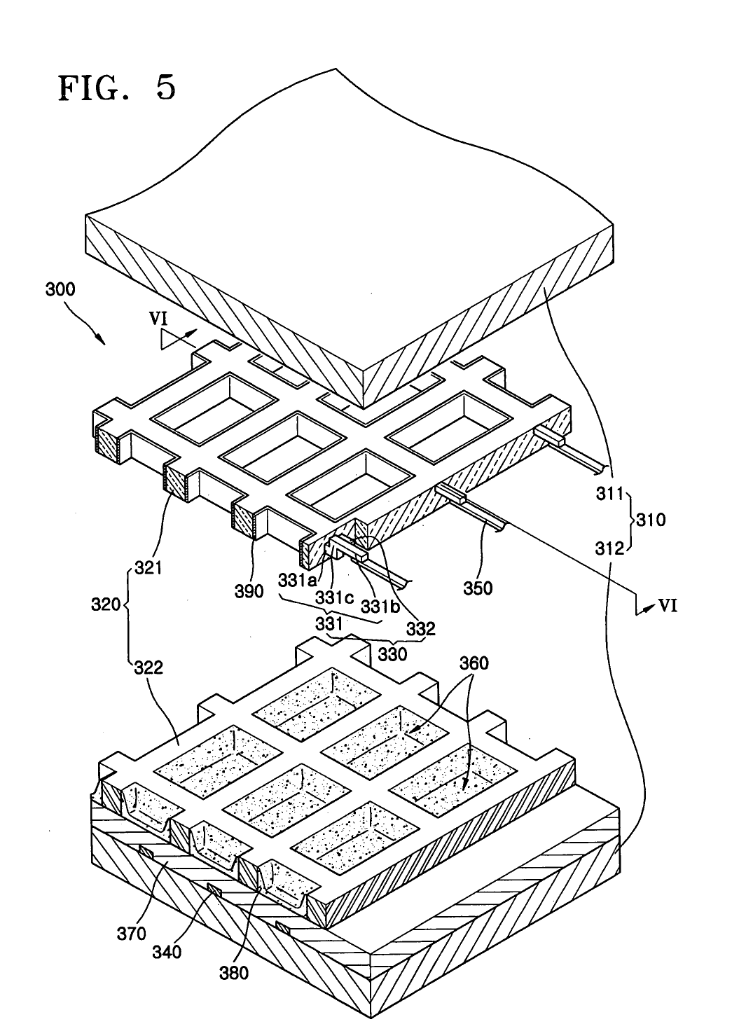

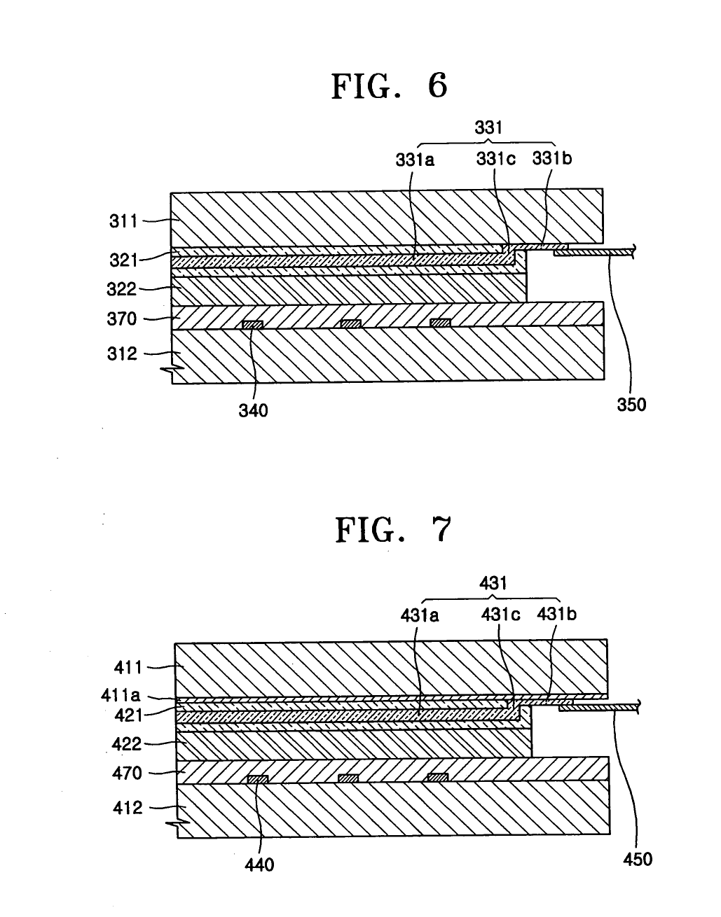

A third embodiment of the present invention will now be described with reference to FIGS. 5 and 6.

FIG. 5 is a cutaway perspective view of a plasma display panel having an electrode terminal part connection structure according to a third embodiment of the present invention. FIG. 6 is a cross sectional view taken along line VI-VI of FIG. 5.

The plasma display panel 300 having the electrode terminal part connection structure according to the third embodiment of the present invention includes a substrate pair 310, a barrier rib 320, sustain electrode pairs 330, address electrodes 340, and signal transmitting means 350.

The substrate pair 310 includes first substrate 311 and second substrate 312 facing each other. The first substrate 311 is made of transparent glass which is capable of transmitting visible light.

More specifically, in the third embodiment, the first substrate 311 is made of transparent glass so that visible light generated by phosphor layers 380 can pass through the first substrate 311. However, the present invention is not limited to this structure. Alternatively, the second substrate 312 may be made of a transparent material so that visible light generated by the phosphor layers 380 can pass through the second substrate 312.

The barrier rib 320 includes first and second barrier ribs 321 and 322, respectively.

The first substrate 311 and second substrate 312 together with the first and second barrier ribs 321 and 322, respectively, define a plurality of discharge cells 360.

The lengths of the first substrate 311 and second substrate 312 are more than lengths of the first and second barrier ribs 321 and 322, respectively. Therefore, the first substrate 311 and second substrate 312, together with the first and second barrier ribs 321 and 322, respectively, can sufficiently define the discharge cells 360. In addition, the signal transmitting means 350 can be easily located in a portion where the first and second barrier ribs 321 and 322, respectively, are not located on the first and second substrates 311 and 312, respectively.

In addition, in the third embodiment, the cross section of each discharge part 360 defined by the first and second barrier ribs 321 and 322, respectively, has the shape of a rectangle. However, the present invention is not limited to this shape. Alternatively, various shapes, such as a triangle, a pentagon, a polygon, a circle, and an ellipse, may be employed.

The first barrier rib 321 is interposed between the first substrate 311 and second substrate 312. The first barrier rib 321 is made of a dielectric material. The sustain electrode pairs 330 are located within the first barrier rib 321.

Although the first barrier rib 321 can be formed so as to extend from the second barrier rib 322, it is preferable that the first barrier rib 321 be formed so as to extend from the first substrate 311.

The dielectric material constituting the first barrier rib 321 prevents charged particles from colliding directly with the sustain electrode pairs 330 in order to protect the sustain electrode pairs 330. In addition, the dielectric material induces the charged particles and accumulates wall charges. The dielectric material is preferably PbO, B₂O₃, SiO₂, or the like.

The sustain electrode pairs 330 located within the first barrier rib 321 serve as discharge electrodes, including common electrode 331 and scan electrode 332.

The second barrier rib 322 is interposed between the first and second substrates 311 and 312, respectively. The second barrier rib 322 is located under the first barrier rib 321, and is made of a dielectric material.

In the third embodiment, since the sustain electrode pairs 330 are located within the first barrier rib 321 of the plasma display panel 300, the common and scan electrodes 331 and 332, respectively, constituting the sustain electrode pair 330 need not be made of a transparent material, but can be made of a highly-conductive (low resistance) metal, such as Ag, Al, or Cu. This provides many advantages, such as faster response rate, lower signal distortion, and reduced power consumption.

In the third embodiment, discharge parts 331a of the common electrode 331 and a discharge part (not shown) of the scan electrodes 332 have a straight line shape. However, the present invention is not limited to this shape. Alternatively, various shapes such as a ladder, a ring and a lateral ring may be employed to surround the discharge cells 360. In this case, the sustain discharge is generated perpendicular to all of the side walls defining the discharge part 360. Therefore, the discharge area can be enlarged, and a low driving voltage can be used, so that it is possible to increase luminous efficiency.

The address electrodes 340 are located on the front surface of the second substrate 312 and extend in a direction intersecting the common and scan electrodes 331 and 332, respectively. The address electrodes 340, together with the scan electrodes 332, perform address discharge so as to select discharge cells where the discharge is to be generated.

In the third embodiment, since the discharge parts 331a of the common electrode 331 and the discharge part (not shown) of the scan electrodes 332 have a straight line shape, the address electrodes 340 must be separate in order to perform address discharge so as to select the discharge cells wherein the discharge is to be generated. However, the present invention is not limited to this structure. Alternatively, as described above, in the case of the plasma display panel wherein the discharge parts of the common and scan electrodes have the shape of a ladder, a ring, or the like so as to surround the discharge cells, a structure wherein the discharge parts of the common and scan electrode intersect each other has an addressing function so that separate address electrodes 340 are not needed.

A dielectric layer 370 is located so as to cover the address electrodes 340. The dielectric layer 370 prevents positive ions or electrons from colliding with the address electrodes 340 in order to protect the address electrodes 340. In addition, the dielectric layer 370 induces charged particles. The dielectric layer 370 is preferably made of PbO, B₂O₃, SiO₂, or the like.

The phosphor layers 380 are located on lower surfaces of the discharge cells 360 and lower side walls of the second barrier rib 322. However, the present invention is not limited to this structure of the phosphor layers 380. Alternatively, the phosphor layers 380 may be located on various regions of the discharge cells 360, for example, on upper surfaces of the discharge cells 360.

The phosphor layer 380 includes the same fluorescent material as the phosphor layers 180 and 280 of the first and second embodiments, respectively, and thus a description thereof is omitted.

A barrier rib protective layer 390 is located on the side walls of the first barrier rib 321 where the phosphor layers 380 are not located.

The barrier rib protective layer 390 is made of the same material, and has the same function, as the barrier rib protective layers 190 and 290 of the first and second embodiments, respectively, and thus a description thereof is omitted.

The discharge cells 360, defined by the first and second substrates 311 and 312, respectively, and the first and second barrier ribs 321 and 322, respectively, are filled with a discharge gas such as Ne, Xe, or a mixture thereof.

As described above, the sustain electrode pairs 330, serving as discharge electrodes, include common and scan electrodes 331 and 332, respectively.

The common and scan electrodes 331 and 332, respectively, have identical structures except that the electrodes are formed symmetrically in order to be easily connected to the driving circuit board (not shown) by the signal transmitting means 350. Therefore, only the common electrode 331 will be representatively described.

The common electrode 331 includes a discharge part 331a, a terminal part 331b, and a connection part 331c. The structure is as follows.

The discharge part 331a is located within a first barrier rib 321 so as to perform discharge.

The terminal part 331b contacts the rear surface of the first substrate 311 so that the first substrate 311 can support the terminal part 331b.

In addition, the terminal part 331b is located outside the second barrier rib 322 so that the terminal part 331b can be connected to the signal transmitting means 350. As described, the lengths of the first and second substrates 311 and 312, respectively, are formed so as to be longer than the lengths of the first and second barrier ribs 321 and 322, respectively, so that there are some portions along the edges of the first and second substrates 311 and 312, respectively, where the first and second barrier ribs 321 and 322, respectively, are not formed. In those portions, the signal transmitting means 350 is electrically connected to the terminal part 331b.

The connection part 331c is formed so as to electrically connect the discharge part 331a to the terminal part 331b.

In the third embodiment, the connection part 331c is located within the first barrier rib 321, but the present invention is not limited thereto. That is, if the connection part 331c can be formed to connect the discharge part 331a to the terminal part 331b, the connection part 331c may be located outside the first barrier rib 321. In addition, in the case where the connection part 331c is located outside the first barrier rib 321, the connection part 331c is covered with a thin insulating layer so as to protect the connection part 331c.

In the third embodiment, the discharge part 331a, the terminal part 331b and the connection part 331c are made of the same material, but the present invention is not limited thereto. For example, the discharge part 331a, the terminal part 331b and the connection part 331c may be made of different materials. That is, if the discharge part 331a, the terminal part 331b and the connection part 331c are constructed of electrically conductive materials, any materials can be selected without particular limitation.

The signal transmitting means 350 is electrically connected to an upper portion of the terminal part 331b. In the third embodiment, the signal transmitting means 350 contacts one of the two surfaces of the terminal part 331b, which is opposite to the lower surface of the terminal part 331b which contacts the first substrate 311.

When the signal transmitting means 350 is attached to the terminal part 331b, an external force is exerted on the terminal part 331b. In the third embodiment, the terminal part 331b contacts the rear surface of the first substrate 311 so that no drooping of the terminal part 331b can occur, and the terminal part 331b can effectively resist a shear force and a bending moment.

The signal transmitting means 350 may be a flexible printed cable (FPC). In this case, the terminal parts 331b are respectively connected to the wires of the flexible printed cable.

In the latter regard, the wires of the signal transmitting means 350 may be connected to the terminal part 331b using an anisotropic conductive film.

As described above, the common electrode 331 has a symmetrical structure relative to the scan electrode 332, so that a discharge part (not shown), a terminal part (not shown) and a connection part (not shown) of the scan electrode 332 have the same structure as the discharge part 331a, the terminal part 331b and the connection part 331c, respectively, of the common electrode 331.

In other words, although not shown in FIGS. 3 and 4, the array structure of the first and second barrier ribs 321 and 322, respectively, the terminal part 331b of the common electrode 331, the connection part 331c, and the signal transmitting means 350 are also formed symmetrically on the opposite edge of the plasma display panel 300.

Next, the operation of a plasma display panel 300 having the electrode terminal part connection structure according to the third embodiment will be described.

First, when the first and second barrier ribs 321 and 322, respectively, and the sustain electrode pairs 330 of the plasma display panel 300 are formed, the discharge part 331a, the terminal part 331b, and the connection part 331c of the common electrode 331, and a discharge part (not shown), a terminal part (not shown), and a connection part (not shown) of the scan electrode 332, are formed with the above-described structures according to the third embodiment. Next, the wires of the signal transmitting means 350 are electrically connected to the terminal part 331b of the common electrode 331 and the terminal part (not shown) of the scan electrode 332.

After assembling the plasma display panel 300 and injecting the discharge gas, an address voltage is applied to the address electrode 340 and the scan electrode 332 by an external power source (not shown) so as to generate address discharge. The address discharge selects a discharge part 360 wherein sustain discharge is to be generated.

After that, a discharge sustain voltage is applied to the common and scan electrodes 331 and 332, respectively, of the selected discharge cell 360 through the signal transmitting means 350, so that wall charges accumulated on the common and scan electrodes 331 and 332, respectively, move so as to generate a sustain discharge. When the discharge gas excited during the sustain discharge drops to a lower energy state, UV light is emitted.

Next, the UV light excites the phosphor layer 380 coated in the discharge part 360. When the excited phosphor layer 380 drops to a lower energy state, visible light is emitted. The visible light passes out through the first substrate 311 so as to form an image which can be viewed by a user.

In the third embodiment, the terminal part 331b of the common electrode 331 and the terminal part (not shown) of the scan electrode 332 contact the rear surface of the first substrate 311, so that the terminal part 331b of the common electrode 331 and the terminal part (not shown) of the scan electrode 332 can be stably supported. Accordingly, when wires of the signal transmitting means 350 are connected to the terminal part 331b of the common electrode 331 and the terminal part (not shown) of the scan electrode 332, although an external force is exerted on the terminal parts, the terminal parts are protected from breakage.

Now, a modified version of the third embodiment of the present invention will be described with reference to FIG. 7. The description focuses mainly on the differences between the modified version and the third embodiment.

FIG. 7 is a cross sectional view of a plasma display panel having an electrode terminal part connection structure according to a modified version of the third embodiment of the present invention.

As shown in FIG. 7, a first barrier rib 421, a second barrier rib 422, a common electrode 431, a scan electrode (not shown), an address electrode 440, and a dielectric layer 470 are located between the first and second substrates 411 and 412, respectively.

According to the modified version of the third embodiment, first substrate 411 includes a substrate protective layer 411a, and common electrode 431 includes a discharge part 431a, a terminal part 431b, and a connection part 431c.

The discharge part 431a is located within the first barrier rib 421 so as to perform discharge therein. The terminal part 431b is electrically connected to a signal transmitting means 450. The connection part 431c connects the discharge part 431a to the terminal part 431b.

The terminal part 431b contacts the substrate protective layer 411a of the first substrate 411 so that the terminal part 431b can be supported by the first substrate 411.

According to the modified version of the third embodiment, first substrate 411 includes a substrate protective layer 411a, which protects the substrates 411. In addition, the substrate protective layer 411a reduces discharge voltage by emitting secondary electrons. The substrate protective layer 411a is preferably made of magnesium oxide (MgO).

The substrate protective layer 411a is not an essential component for the plasma display panel as described above in the first, second and third embodiments. However, if the substrate protective layer 411a is provided, as in the modified version of the third embodiment, discharge voltage can be reduced during discharge, and it is possible to increase discharge efficiency.

On the other hand, since the common electrode 431 has a symmetrical structure relative to scan electrode (not shown), a discharge part (not shown), a terminal part (not shown) and a connection part (not shown) of the scan electrode (not shown), and the first substrate 411, have the same structure as the discharge part 431a, the terminal part 431b and the connection part 431c of the common electrode 431, and the first substrate 411, respectively.

According to the modified version of the third embodiment, the terminal part 431b of the common electrode 431 and the terminal part (not shown) of the scan electrode contact the rear surface of the first substrate 411 including the substrate protective layer 411a, so that the terminal part 431b of the common electrode 431 and the terminal part (not shown) of the scan electrode can be stably supported. Therefore, when the wires of the signal transmitting means 450 are connected to the terminal part 431b of the common electrode 431 and the terminal part (not shown) of the scan electrode, although an external force is exerted on the terminal parts, the terminal parts are protected from breakage.

According to the present invention, in a plasma display panel having an electrode terminal part connection structure, a terminal of a discharge electrode contacts a substrate or a dielectric layer, so that signal transmitting means can be stably connected to the terminal part of the discharge electrode.

Moreover, according to the present invention, when the wires of the signal transmitting means are connected to the terminal part of the discharge electrode, although an external force is exerted on the terminal parts, the terminal parts are protected from breakage by the substrate or the dielectric layer supporting the terminal parts, and the terminal parts can be stably supported, so that the signal transmitting means can be easily mounted and the defect rate can be reduced. Therefore, the number of production processes and production cost can be reduced.

In addition to being applicable to a facing discharge plasma display panel, the present invention can also be directly applied to a new plasma display panel wherein a discharge electrode is located within a barrier rib. Since the present invention can be applied to all plasma display panels having a structure wherein a discharge electrode is located within the barrier rib, it is possible to reliably and efficiently implement a plasma display panel.

While the present invention has been particularly shown and described with reference to exemplary embodiments thereof, it will be understood by those skilled in the art that various changes in form and detail may be made therein without departing from the spirit and scope of the present invention as defined by the appended claims.

What is claimed is:

1. An electrode terminal part connection structure for a plasma display panel, comprising:
a pair of substrates facing each other;
a barrier rib interposed between the substrates so as to define discharge cells together with the substrates;
a dielectric layer interposed between the substrates;
discharge electrodes, each having a discharge part located within the barrier rib, a terminal part located outside the barrier rib and contacting the dielectric layer, and a connection part connecting the discharge part to the terminal part; and
signal transmitting means having an end portion which contacts the terminal parts for transmitting a signal thereto.

2. The electrode terminal part connection structure according to claim 1, wherein lengths of the substrates are more than a length of the barrier rib.

3. The electrode terminal part connection structure according to claim 1, wherein a side wall of the barrier rib is covered by a barrier rib protective layer.

4. The electrode terminal part connection structure according to claim 1, wherein the discharge electrodes are common electrodes.

5. The electrode terminal part connection structure according to claim 1, wherein the discharge electrodes are scan electrodes.

6. The electrode terminal part connection structure according to claim 1, wherein the signal transmitting means comprise flexible printed cables.

7. The electrode terminal part connection structure according to claim 1, wherein the signal transmitting means are connected to the terminal parts using an anisotropic conductive film.

8. An electrode terminal part connection structure for a plasma display panel, comprising:
a pair of substrates facing each other;
a barrier rib interposed between the substrates so as to define discharge cells together with the substrates;
discharge electrodes, each having a discharge part located within the barrier rib, a terminal part located outside the barrier rib and contacting one of the substrates, and a connection part connecting the discharge part to the terminal part; and
signal transmitting means having an end portion which contacts the terminal part for transmitting a signal thereto.

9. The electrode terminal part connection structure according to claim 8, wherein lengths of the substrates are more than a length of the barrier rib.

10. The electrode terminal part connection structure according to claim 8, wherein a surface of at least one of the substrates is covered by a substrate protective layer.

11. The electrode terminal part connection structure according to claim 8, wherein a side wall of the barrier rib is covered by a barrier rib protective layer.

12. The electrode terminal part connection structure according to claim 8, wherein the discharge electrodes are common electrodes.

13. The electrode terminal part connection structure according to claim 8, wherein the discharge electrodes are scan electrodes.

14. The electrode terminal part connection structure according to claim 8, wherein the signal transmitting means comprise flexible printed cables.

15. The electrode terminal part connection structure according to claim 8, wherein the signal transmitting means are connected to the terminal parts using an anisotropic conductive film.

16. An electrode terminal part connection structure for a plasma display panel, comprising:
a pair of substrates facing each other;
a first barrier rib interposed between the substrates so as to define discharge cells together with the substrates;
a second barrier rib interposed between the substrates so as to define the discharge cells together with the substrates and the first barrier rib;
a dielectric layer interposed between the substrates;
discharge electrodes, each having a discharge part located within the first barrier rib, a terminal part located outside the second barrier rib and contacting the dielectric layer, and a connection part connecting the discharge part to the terminal part; and
signal transmitting means having an end portion which contacts the terminal parts for transmitting a signal thereto.

17. The electrode terminal part connection structure according to claim 16, wherein lengths of the substrates are more than a length of the first barrier rib.

18. The electrode terminal part connection structure according to claim 16, wherein lengths of the substrates are more than a length of the second barrier rib.

19. The electrode terminal part connection structure according to claim 16, wherein a side wall of the first barrier rib is covered by a barrier rib protective layer.

20. The electrode terminal part connection structure according to claim 16, wherein the discharge electrodes are common electrodes.

21. The electrode terminal part connection structure according to claim 16, wherein the discharge electrodes are scan electrodes.

22. The electrode terminal part connection structure according to claim 16, wherein the signal transmitting means comprise flexible printed cables.

23. The electrode terminal part connection structure according to claim 16, wherein the signal transmitting means are connected to the terminal parts using an anisotropic conductive film.

24. An electrode terminal part connection structure for a plasma display panel, comprising:
a pair of substrates facing each other;
a first barrier rib interposed between the substrates so as to define discharge cells together with the substrates;
a second barrier rib interposed between the substrates so as to define the discharge cells together with the substrates and the first barrier rib;
discharge electrodes, each having a discharge part located within the first barrier rib, a terminal part located outside the second barrier rib and contacting one of the substrates, and a connection part connecting the discharge part to the terminal part; and
signal transmitting means having an end portion which contacts the terminal parts for transmitting a signal thereto.

25. The electrode terminal part connection structure according to claim 24, wherein lengths of the substrates are more than a length of the first barrier rib.

26. The electrode terminal part connection structure according to claim 24, wherein lengths of the substrates are more than a length of the second barrier rib.

27. The electrode terminal part connection structure according to claim 24, wherein a surface of at least one of the substrates is covered by a substrate protective layer.

28. The electrode terminal part connection structure according to claim 24, wherein a side wall of the first barrier rib is covered by a barrier rib protective layer.

29. The electrode terminal part connection structure according to claim 24, wherein the discharge electrodes are common electrodes.

30. The electrode terminal part connection structure according to claim 24, wherein the discharge electrodes are scan electrodes.

31. The electrode terminal part connection structure according to claim 24, wherein the signal transmitting means comprise flexible printed cables.

32. The electrode terminal part connection structure according to claim 24, wherein the signal transmitting are connected to the terminal parts using an anisotropic conductive film.

33. A plasma display panel, comprising:
a pair of substrates facing each other;
a barrier rib interposed between the substrates so as to define discharge cells together with the substrates;
a dielectric layer interposed between the substrates;
sustain electrodes, each having a discharge part located within the barrier rib, a terminal part located outside the barrier rib and contacting the dielectric layer, and a connection part connecting the discharge part to the terminal part;
address electrodes interposed between the substrates and extending in a direction intersecting a direction of the sustain electrodes;
signal transmitting means having an end portion which contacts the terminal parts for transmitting a signal thereto;
phosphor layers located in the discharge cells; and
a discharge gas filling the discharge cells.

34. The plasma display panel according to claim 33, wherein lengths of the substrates are more than a length of the barrier rib.

35. The plasma display panel according to claim 33, wherein at least one of the substrates is transparent.

36. The plasma display panel according to claim 33, wherein a side wall of the barrier rib is covered by a barrier rib protective layer.

37. The plasma display panel according to claim 33, wherein each of the sustain electrodes comprises one of a common electrode and a scan electrode.

38. The plasma display panel according to claim 33, wherein the signal transmitting means comprise flexible printed cables.

39. The plasma display panel according to claim 33, wherein the signal transmitting means are connected to the terminal parts using an anisotropic conductive film.

40. A plasma display panel, comprising:
a pair of substrates facing each other;
a barrier rib interposed between the substrates so as to define discharge cells together with the substrates;
sustain electrodes, each having a discharge part located within the barrier rib, a terminal part located outside the barrier rib and contacting one of the substrates, and a connection part connecting the discharge part to the terminal part;
address electrodes interposed between the substrates and extending in a direction intersecting a direction of the sustain electrodes;
signal transmitting means having an end portion which contacts the terminal parts for transmitting a signal thereto;
phosphor layers located in the discharge cells; and
a discharge gas filling the discharge cells.

41. The plasma display panel according to claim 40, wherein lengths of the substrates are more than a length of the barrier rib.

42. The plasma display panel according to claim 40, wherein at least one of the substrates is transparent.

43. The plasma display panel according to claim 40, wherein a surface of at least one of the substrates is covered by a substrate protective layer.

44. The plasma display panel according to claim 40, wherein a side wall of the barrier rib is covered by a barrier rib protective layer.

45. The plasma display panel according to claim 40, wherein each of the sustain electrodes comprises one of a common electrode and a scan electrode.

46. The plasma display panel according to claim 40, wherein the signal transmitting means comprise flexible printed cables.

47. The plasma display panel according to claim 40, wherein the signal transmitting means are connected to the terminal parts using an anisotropic conductive film.
